(19) United States
(12) Patent Application Publication
(10) Pub. No.: US 2014/0325540 A1
(43) Pub. Date: Oct. 30, 2014

(54) MEDIA SYNCHRONIZED ADVERTISING OVERLAY

(71) Applicant: MICROSOFT CORPORATION, Redmond, WA (US)

(72) Inventors: Enrique de la Garza, Sammamish, WA (US); Alexei Pineda, Bellevue, WA (US); Joshua Lawrence Munsee, Bellevue, WA (US); Karin Zilberstein, Kirkland, WA (US); Jonhenry A. Righter, Bellevue, WA (US); Michael Patrick Mott, Sammamish, WA (US)

(73) Assignee: Microsoft Corporation, Redmond, WA (US)

(21) Appl. No.: 13/872,258

(22) Filed: Apr. 29, 2013

(51) Int. Cl. H04N 21/442; H04N 21/81

(52) U.S. Cl. CPC H04N 21/44218; H04N 21/812
USPC 725/12

(57) ABSTRACT

Embodiments of the present invention provide an overlay experience that is coordinated with both a present media presentation and the media presentation's current audience. Exemplary media presentations include television, movies, games, and music. An overlay is visible content displayed concurrently with primary content. The overlay may obscure part of the primary content, but not all of the primary content. Embodiments of the present invention use audience data to select an appropriate overlay from one of several overlays available. The audience data may be derived from image data generated by an image-capture device, such as a video camera, that has a view of the audience area. Automated image analysis may be used to generate audience data that is used to select the overlay.

### BACKGROUND

Advertisements are shown before, during, and after media presentations. Advertisements are even included within media presentations through product placement. The advertisements shown with the media are selected based on anticipated audience demographics. The audience demographics may be estimated through audience studies conducted on similar media presentations.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide an overlay experience that is coordinated with both a present media presentation and the media presentation's current audience. Exemplary media presentations include television, movies, games, and music. An overlay is visible content displayed concurrently with primary content. The overlay may obscure part of the primary content, but not all of the primary content.

Embodiments of the present invention use audience data to select an appropriate overlay from one of several overlays available. The audience data may be derived from image data generated by an imaging device, such as a video camera, that has a view of the audience area. Automated image analysis may be used to generate audience data that is used to select the overlay.

The audience data derived from the image data includes number of people present in the audience, engagement level of people in the audience, personal characteristics of those individuals, and response to the media content. Different levels of engagement may be assigned to audience members. A member's attentiveness may be classified into one or more categories or levels. The categories may range from not paying attention to full attention.

Audience data may include a person's reaction to a media content. The person's reaction may be measured by studying biometrics gleaned from the imaging data to determine whether the person likes or dislikes a media content. For example, heartbeat and facial flushing may be detected in the image data. Similarly, pupil dilation and other facial expressions may be associated with different reactions. All of these biometric characteristics may be interpreted by a classifier to determine whether the person likes or dislikes a media content.

The audience data may be used to determine when an overlay is displayed. For example, an overlay may not be displayed when a person shows a low level of attentiveness. A person's reaction to a first overlay or other media content may be used to determine whether a second, related overlay, is displayed.

In addition to determining when the overlay is shown and what overlay is shown based on engagement levels, personal characteristics of audience members may also be considered when selecting an overlay. The personal characteristics of the audience members include demographic data that may be discerned from image classification or from associating the person with a known personal account. Personal characteristics may also include previous viewing history and/or interactions with overlays displayed previously.

The demographic information for individuals in the audience may be used to personalize the overlay. For example, personal account information may be used to generate a social overlay. A social overlay includes information derived from an individual's social network. For example, a social overlay could indicate that five friends in their social network like a particular primary media content. Other data sources and/or services such as the users' social network, purchase history, or recent viewing history may be used to personalize or select a specific overaly.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of entertainment environment, in accordance with an embodiment of the present invention;

FIG. 3 is a diagram of a remote entertainment environment, in accordance with an embodiment of the present invention;

FIG. 4 is a diagram of an exemplary audience area that illustrates presence, in accordance with an embodiment of the present invention;

FIG. 5 is a diagram of an exemplary audience area that illustrates audience member attention levels, in accordance with an embodiment of the present invention;

FIG. 6 is a diagram of an exemplary audience area that illustrates audience member response to media content, in accordance with an embodiment of the present invention;

FIG. 7 is a diagram of an exemplary audience area that illustrates a social overlay, in accordance with an embodiment of the present invention;

FIG. 8 is a diagram of an exemplary audience area that illustrates an interactive social overlay, in accordance with an embodiment of the present invention;

FIG. 9 is a flow chart showing a method of selecting an overlay for an ongoing media presentation using audience data, in accordance with an embodiment of the present invention;

FIG. 10 is a flow chart showing a method of generating a social overlay, in accordance with an embodiment of the present invention; and

FIG. 11 is a flow chart showing a method of managing an overlay display, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an overlay experience that is coordinated with both a present media presentation and the media presentation's current audience. Exemplary media presentations include television, movies, games, and music. The audience includes individuals able to perceive the media presentation because of their proximity to an entertainment device generating the media presentation. For example, a television's audience could be those people that are able to view the television.

An overlay is visible content displayed concurrently with primary content. The overlay may obscure part of the primary content, but not all of the primary content. For example, the overlay may be displayed along the side or bottom of a screen. However, embodiments of the present invention are not limited to overlays that remain on the periphery of the screen. Some overlays may obscure parts of the primary content, at least temporarily. In some instances the overlay may not necessarily cover any part of the primary content—the primary content may be “shrunk” to accommodate the overlay, which may be displayed side-by-side with the primary content.

Embodiments of the present invention use audience data to select an appropriate overlay from one of several overlays available. The audience data may be derived from image data generated by an imaging device, such as a video camera, that has a view of the audience area. Automated image analysis may be used to generate useful audience data that is used to select the overlay.

The audience data derived from the image data includes number of people present in the audience, engagement level of people in the audience, personal characteristics of those individuals, and response to the media content. Different levels of engagement may be assigned to audience members. Image data may be analyzed to determine how many people are present in the audience and characteristics of those people.

Audience data includes a level of engagement or attentiveness. A person's attentiveness may be classified into one or more categories or levels. The categories may range from not paying attention to full attention. A person that is not looking at the television and is in a conversation with somebody else, either in the room or on the phone, may be classified as not paying attention or fully distracted. On the other hand, somebody in the room that is not looking at the TV, but is not otherwise obviously distracted, may have a medium level of attentiveness. Someone that is looking directly at the television without an apparent distraction may be classified as fully attentive. A machine-learning image classifier may assign the levels of attentiveness by analyzing image data.

Audience data may include a person's reaction to the media content. The person's reaction may be measured by studying biometrics gleaned from the imaging data. For example, heartbeat and facial flushing may be detected in the image data. Similarly, pupil dilation and other facial expressions may be associated with different reactions. All of these biometric characteristics may be interpreted by a classifier to determine whether the person likes or dislikes a media content. Other data sources and/or services such as the users' social network, purchase history, or recent viewing history may be used to generate audience data.

The different audience data may be used to determine when an overlay is displayed. For example, an overlay may not be displayed when a person is present but shows a low level of attentiveness. An advertiser may specify that an overlay is only shown when one or more of the individuals present are fully attentive. Alternatively, the advertiser may pay different amounts, depending on the level of attentiveness observed in each person present in the audience when the overlay is displayed.

A person's reaction to a first overlay or other media content may be used to determine whether a second, related overlay, is displayed. For example, a person classified as having a negative reaction to a first commercial (primary content) may not be shown the overlay for the same product later in a show (secondary content). Alternatively, a person that responds positively to a commercial may be shown a related overlay at a subsequent opportunity during the show or anytime in the future.

In another embodiment, a series of related overlays may be shown to the person. However, the next overlay in the series may be shown only once an engagement level indicating a certain level of attentiveness is recorded in association with the overlay presentation.

In addition to determining when the overlay is shown and what overlay is shown based on engagement levels, personal characteristics of audience members may also be considered when selecting an overlay. Personal characteristics may include previous viewing history and/or interactions with overlays displayed previously. The personal characteristics of the audience members include demographic data that may be discerned from image classification or from associating the person with a known personal account. For example, an entertainment company may require that the person submit a name, age, address, and other demographic information to maintain a personal account. The personal account may be associated with a facial recognition program that is used to authenticate the person. Regardless of whether the entertainment company is providing the primary content, the facial recognition record associated with the personal account could be used to identify the person associated with the account in the audience. In some situations, all of the audience members may be associated with an account that allows precise demographic information to be associated with each audience member.

The demographic information for individuals in the audience may be used to personalize the overlay. For example, personal account information may be used to generate a social overlay. A social overlay includes information derived from an individual's social network. For example, a social overlay could indicate that five friends in their social network like a particular primary media content. The social overlay may allow the person to generate a social post related to the content being displayed. For example, the person may be able to speak a comment that is automatically translated through speech recognition into a textual post. The person may be asked to confirm the text and may be given an opportunity to edit it before posting. The post may automatically reference the media content being displayed, including a specific point in the media content. The social overlay may have an advertising sponsor. The ad sponsor's blurb could be included in the social post when generated through the sponsored social overlay.

The overlay's location on the screen may be chosen based on the audience data. For example, an overlay directed to a particular person in the audience on the right side of the room may be displayed on the right side of the display. In one embodiment, multiple overlays are displayed and arranged for the convenience of the people to which they are directed. For example, two people on the couch could each have an overlay customized for them and presented on the right or left hand side of the screen closest to where they are seated. The overlay could be customized based on viewer interests, viewer input, the viewer's social network friends, etc.

In one embodiment, an overlay is used to determine what content is shown in the next commercial break. An initial overlay is presented during a primary content inviting the audience member to respond positively to a product in a show. The product could be placed in the show via product placement. Or the product could be identified using automatic content recognition. Either way, a positive response to the overlay will result in a related ad being shown during the next commercial break. In the product placement embodiment, the product in the show, overlay, and eventual commercial could be coordinated. For example, the overlay could invite a viewer to express interest in a car appearing in a movie by making a driving gesture (e.g., hands on an imaginary steering wheel). Upon detecting the driving gesture, a commercial could be dynamically slotted into the next commercial break. The user could also be sent a related advertisement via email or contemporaneously on a companion device, such as a tablet.

When automatic content recognition is used instead of product placement, an advertisement could be selected based on the expressed interest. For example, a car commercial could be shown for the car appearing in the content or a similar car. In one embodiment, the opportunity to show an advertisement to a viewer expressing interest in cars is auctioned to the highest bidder in real-time. Along with the expressed interest in a product category, other viewer characteristics may be included within the auction for the advertising opportunity.

In one embodiment, a privacy interface is provided. The privacy interface explains how audience data is gathered and used. The audience member is given the opportunity to opt-in or opt-out of all or some uses of the audience data. For example, the audience member may authorize use of explicit audience responses, but opt-out of implicit responses.

As explained in more detail subsequently, audience data and/or viewing records may be abstracted into a persona before sharing with advertisers or otherwise complied. The use of personas maintains the privacy of individual audience members by obscuring personally identifiable information. For example, a viewing record may be recorded as a male, age 25-30, watched commercial YZ and responded positively. The actual viewer is not identified in audience data, even when some information (e.g., age) may be ascertained from a user account that includes personally identified information.

Having briefly described an overview of embodiments of the invention, an exemplary operating environment suitable for use in implementing embodiments of the invention is described below.

### Exemplary Operating Environment

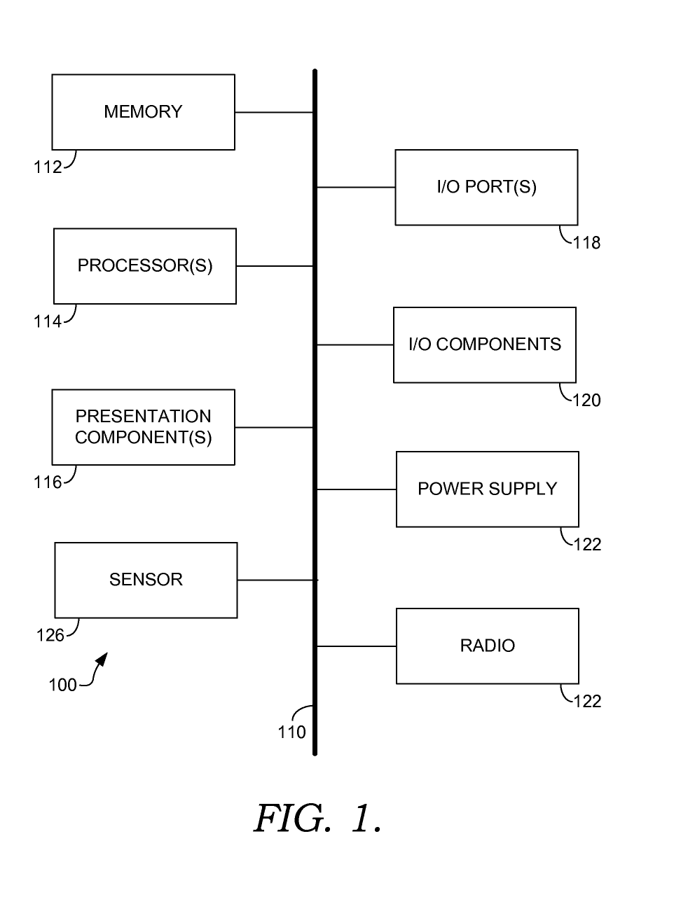

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Entertainment Environment

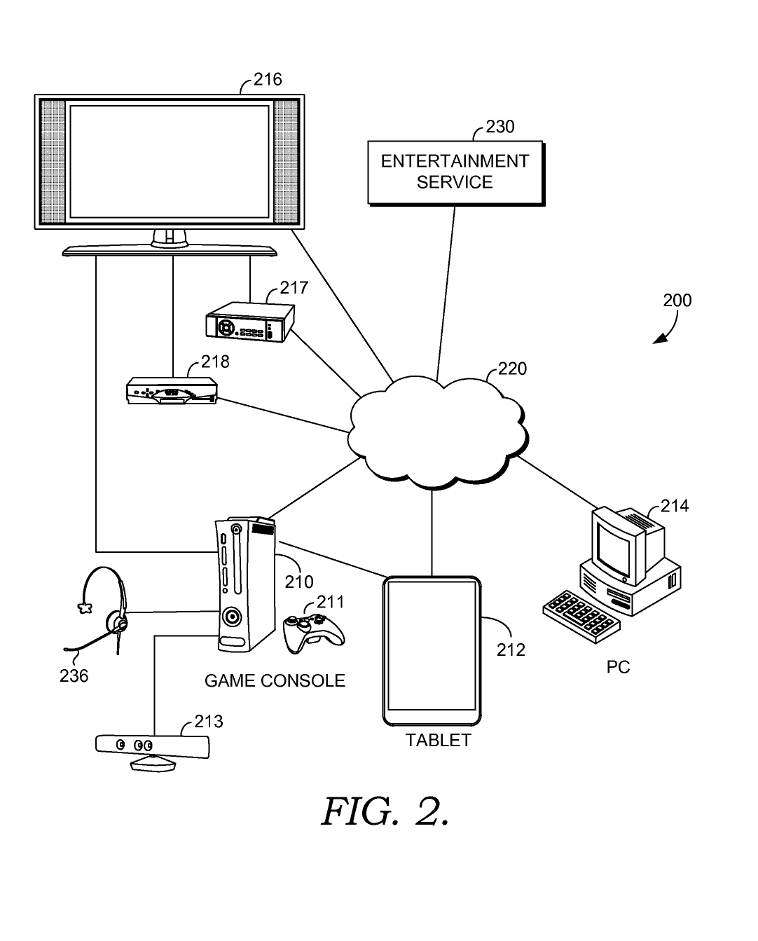

Turning now to FIG. 2, an online entertainment environment 200 is shown, in accordance with an embodiment of the present invention. The online entertainment environment 200 comprises various entertainment devices connected through a network 220 to an entertainment service 230. Exemplary entertainment devices include a game console 210, a tablet 212, a personal computer 214, a digital video recorder 217, a cable box 218, and a television 216. Use of other entertainment devices not depicted in FIG. 2, such as smart phones, is also possible.

The game console 210 may have one or more game controllers communicatively coupled to it. In one embodiment, the tablet 212 may act as an input device for the game console 210 or the personal computer 214. In another embodiment, the tablet 212 is a stand-alone entertainment device. Network 220 may be a wide area network, such as the Internet. As can be seen, most devices shown in FIG. 2 could be directly connected to the network 220. The devices shown in FIG. 2, are able to communicate with each other through the network 220 and/or directly as indicated by the lines connecting the devices.

The controllers associated with game console 210 include a game pad 211, a headset 236, an imaging device 213, and a tablet 212. Tablet 212 is shown coupled directly to the game console 210, but the connection could be indirect through the Internet or a subnet. In one embodiment, the entertainment service 230 helps make a connection between the tablet 212 and the game console 210. The tablet 212 is capable of generating numerous input streams and may also serve as a display output mechanism. In addition to being a primary display, the tablet 212 could provide supplemental information related to primary information shown on a primary display, such as television 216. The input streams generated by the tablet 212 include video and picture data, audio data, movement data, touch screen data, and keyboard input data.

The headset 236 captures audio input from a player and the player's surroundings and may also act as an output device, if it is coupled with a headphone or other speaker.

The imaging device 213 is coupled to game console 210. The imaging device 213 may be a video camera, a still camera, a depth camera, or a video camera capable of taking still or streaming images. In one embodiment, the imaging device 213 includes an infrared light and an infrared camera. The imaging device 213 may also include a microphone, speaker, and other sensors. In one embodiment, the imaging device 213 is a depth camera that generates three-dimensional image data. The three-dimensional image data may be a point cloud or depth cloud. The three-dimensional image data may associate individual pixels with both depth data and color data. For example, a pixel within the depth cloud may include red, green, and blue color data, and X, Y, and Z coordinates. Stereoscopic depth cameras are also possible. The imaging device 213 may have several image-gathering components. For example, the imaging device 213 may have multiple cameras. In other embodiments, the imaging device 213 may have multidirectional functionality. In this way, the imaging device 213 may be able to expand or narrow a viewing range or shift its viewing range from side to side and up and down.

The game console 210 may have image-processing functionality that is capable of identifying objects within the depth cloud. For example, individual people may be identified along with characteristics of the individual people. In one embodiment, gestures made by the individual people may be distinguished and used to control games or media output by the game console 210. The game console 210 may use the image data, including depth cloud data, for facial recognition purposes to specifically identify individuals within an audience area. The facial recognition function may associate individuals with an account associated with a gaming service or media service, or used for login security purposes, to specifically identify the individual.

In one embodiment, the game console 210 uses microphone, and/or image data captured through imaging device 213 to identify content being displayed through television 216. For example, a microphone may pick up the audio data of a movie being generated by the cable box 218 and displayed on television 216. The audio data may be compared with a database of known audio data and the data identified using automatic content recognition techniques, for example. Content being displayed through the tablet 212 or the PC 214 may be identified in a similar manner. In this way, the game console 210 is able to determine what is presently being displayed to a person regardless of whether the game console 210 is the device generating and/or distributing the content for display.

The game console 210 may include classification programs that analyze image data to generate audience data. For example, the game console 210 may determine number of people in the audience, audience member characteristics, levels of engagement, and audience response.

In another embodiment, the game console 210 includes a local storage component. The local storage component may store user profiles for individual persons or groups of persons viewing and/or reacting to media content. Each user profile may be stored as a separate file, such as a cookie. The information stored in the user profiles may be updated automatically. Personal information, viewing histories, viewing selections, personal preferences, the number of times a person has viewed known media content, the portions of known media content the person has viewed, a person's responses to known media content, and a person's engagement levels in known media content may be stored in a user profile associated with a person. As described elsewhere, the person may be first identified before information is stored in a user profile associated with the person. In other embodiments, a person's characteristics may be first recognized and mapped to an existing user profile for a person with similar or the same characteristics. Demographic information may also be stored. Each item of information may be stored as a “viewing record” associated with a particular type of media content. As well, viewer personas, as described below, may be stored in a user profile.

Entertainment service 230 may comprise multiple computing devices communicatively coupled to each other. In one embodiment, the entertainment service is implemented using one or more server farms. The server farms may be spread out across various geographic regions including cities throughout the world. In this scenario, the entertainment devices may connect to the closest server farms. Embodiments of the present invention are not limited to this setup. The entertainment service 230 may provide primary content and secondary content. Primary content may include television shows, movies, and video games. Secondary content may include advertisements, social content, directors' information and the like.

FIG. 2 also includes a cable box 218 and a DVR 217. Both of these devices are capable of receiving content through network 220. The content may be on-demand or broadcast as through a cable distribution network. Both the cable box 218 and DVR 217 have a direct connection with television 216. Both devices are capable of outputting content to the television 216 without passing through game console 210. As can be seen, game console 210 also has a direct connection to television 216. Television 216 may be a smart television that is capable of receiving entertainment content directly from entertainment service 230. As mentioned, the game console 210 may perform audio analysis to determine what media title is being output by the television 216 when the title originates with the cable box 218, DVR 217, or television 216.

### Exemplary Advertising and Content Service

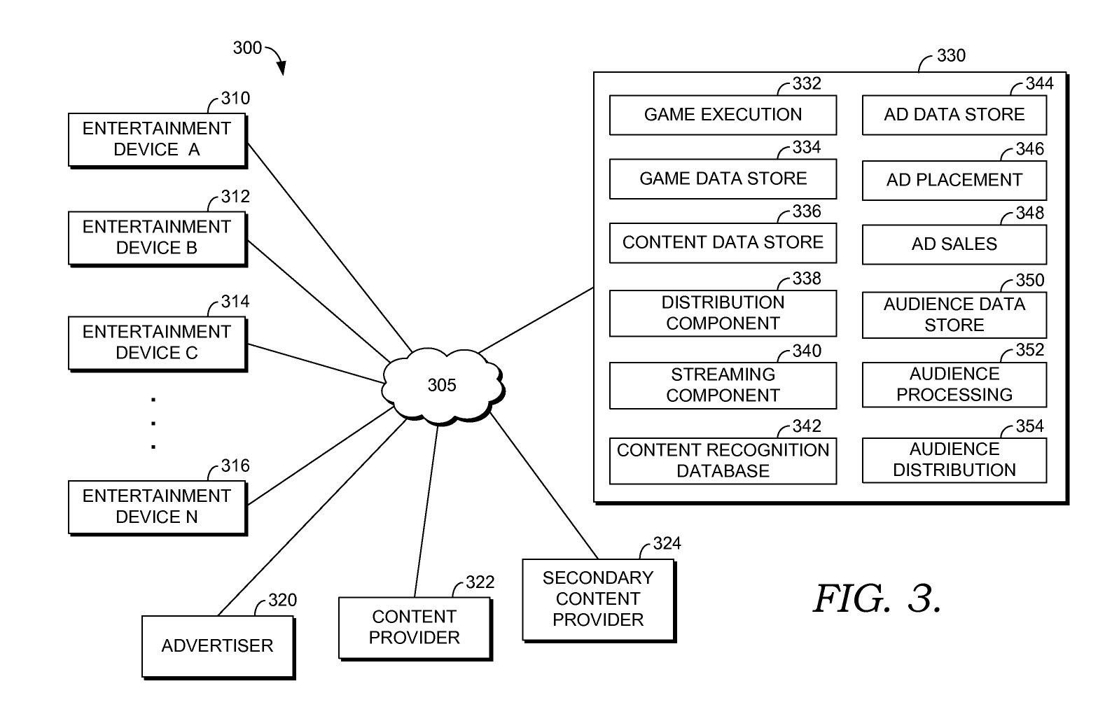

Turning now to FIG. 3, a distributed entertainment environment 300 is shown, in accordance with an embodiment of the present invention. The entertainment environment 300 includes entertainment device A 310, entertainment device B 312, entertainment device C 314, and entertainment device N 316 (hereafter entertainment devices 310-316). Entertainment device N 316 is intended to represent that there could be an almost unlimited number of clients connected to network 305. The entertainment devices 310-316 may take different forms. For example, the entertainment devices 310-316 may be game consoles, televisions, DVRs, cable boxes, personal computers, tablets, or other entertainment devices capable of outputting media. In addition, the entertainment devices 310-316 are capable of gathering viewer data through an imaging device, similar to imaging device 213 of FIG. 2 that was previously described. The imaging device could be built into a client, such as a web cam and microphone, or could be a stand-alone device.

In one embodiment, the entertainment devices 310-316 include a local storage component configured to store personal profiles for one or more persons. The local storage component is described in greater detail above with reference to the game console 210. The entertainment devices 310-316 may include classification programs that analyze image data to generate audience data. For example, the entertainment devices 310-316 may determine how many people are in the audience, audience member characteristics, levels of engagement, and audience response.

Network 305 is a wide area network, such as the Internet. Network 305 is connected to advertiser 320, content provider 322, and secondary content provider 324. The advertiser 320 distributes advertisements to entertainment devices 310-316. The advertiser 320 may also cooperate with entertainment service 330 to provide advertisements. The content provider 322 provides primary content such as movies, video games, and television shows. The primary content may be provided directly to entertainment devices 310-316 or indirectly through entertainment service 330.

Secondary content provider 324 provides content that compliments the primary content. Secondary content may be a director's cut, information about a character, game help information, and other content that compliments the primary content. The same entity may generate both primary content and secondary content. For example, a television show may be generated by a director that also generates additional secondary content to compliment the television show. The secondary content and primary content may be purchased separately and could be displayed on different devices. For example, the primary content could be displayed through a television while the secondary content is viewed on a companion device, such as a tablet. The advertiser 320, content provider 322, and secondary content provider 324 may stream content directly to entertainment devices or seek to have their content distributed by a service, such as entertainment service 330.

Entertainment service 330 provides content and advertisements to entertainment devices. The entertainment service 330 is shown as a single block. In reality, the functions should be widely distributed across multiple devices. In embodiments of the present invention, the various features of entertainment service 330 described herein may be provided by multiple entities and components. The entertainment service 330 comprises a game execution environment 332, a game data store 334, a content data store 336, a distribution component 338, a streaming component 340, a content fingerprint database 342, an ad data store 344, an ad placement component 346, an ad sales component 348, an audience data store 350, an audience processing component 352, and an audience distribution component 354. As can be seen, the various components may work together to provide content, including games, advertisements, and media titles to a client, and capture audience data. The audience data may be used to specifically target advertisements and/or content to a person. The audience data may also be aggregated and shared with or sold to others.

The game execution environment 332 provides an online gaming experience to a client device. The game execution environment 332 comprises the gaming resources required to execute a game. The game execution environment 332 comprises active memory along with computing and video processing. The game execution environment 332 receives gaming controls, such as controller input, through an I/O channel and causes the game to be manipulated and progressed according to its programming. In one embodiment, the game execution environment 332 outputs a rendered video stream that is communicated to the game device. Game progress may be saved online and associated with an individual person that has an ID through a gaming service. The game ID may be associated with a facial pattern.

The game data store 334 stores game code for various game titles. The game execution environment 332 may retrieve a game title and execute it to provide a gaming experience. Alternatively, the content distribution component 338 may download a game title to an entertainment device, such as entertainment device A 310.

The content data store 336 stores media titles, such as songs, videos, television shows, and other content. The distribution component 338 may communicate this content from content data store 336 to the entertainment devices 310-316. Once downloaded, an entertainment device may play the content on or output the content from the entertainment device. Alternatively, the streaming component 340 may use content from content data store 336 to stream the content to the person.

The content fingerprint database 342 includes a collection of audio clips associated with known media titles that may be compared to audio input received at the entertainment service 330. As described above, the received audio input (e.g., received from the game console 210 of FIG. 2) is mapped to the library of known media titles. Upon mapping the audio input to a known media title, the source of the audio input (i.e., the identity of media content) may be determined. The identified media title/content is then communicated back to the entertainment device (e.g., the game console) for further processing. Exemplary processing may include associating the identified media content with a person that viewed or is actively viewing the media content and storing the association as a viewing record.

The entertainment service 330 also provides advertisements. Advertisements available for distribution may be stored within ad data store 344. The advertisements may be presented as an overlay in conjunction with primary content and may be partial or full-screen advertisements that are presented between segments of a media presentation or between the beginning and end of a media presentation, such as a television commercial. The advertisements may be associated with audio content. Additionally, the advertisements may take the form of secondary content that is displayed on a companion device in conjunction with a display of primary content. The advertisements may also be presented when a person associated with a targeted persona is located in the audience area and/or is logged in to the entertainment service 330, as further described below.

The ad placement component 346 determines when an advertisement should be displayed to a person and/or what advertisement should be displayed. The ad placement component 346 may consume real-time audience data and automatically place an advertisement associated with a highest-bidding advertiser in front of one or more viewers because the audience data indicates that the advertiser's bidding criteria is satisfied. For example, an advertiser may wish to display an advertisement to men present in Kansas City, Mo. When the audience data indicates that one or more men in Kansas City are viewing primary content, an ad could be served with that primary content. The ad may be inserted into streaming content or downloaded to the various entertainment devices along with triggering mechanisms or instructions on when the advertisement should be displayed to the person. The triggering mechanisms may specify desired audience data that triggers display of the ad.

The ad sales component 348 interacts with advertisers 320 to set a price for displaying an advertisement. In one embodiment, an auction is conducted for various advertising space. The auction may be a real-time auction in which the highest bidder is selected when a viewer or viewing opportunity satisfies the advertiser's criteria.

The audience data store 350 aggregates and stores audience data received from entertainment devices 310-316. The audience data may first be parsed according to known types or titles of media content. Each item of audience data that relates to a known type or title of media content is a viewing record for that media content. Viewing records for each type of media content may be aggregated, thereby generating viewing data. The viewing data may be summarized according to categories. Exemplary categories include a total number of persons that watched the content, the average number of persons per household that watched the content, a number of times certain persons watched the content, a determined response of people toward the content, a level of engagement of people in the media title, a length of time individuals watched the content, the common distractions that were ignored or engaged in while the content was being displayed, and the like. The viewing data may similarly be summarized according to types of persons that watched the known media content. For example, personal characteristics of the persons, demographic information about the persons, and the like may be summarized within the viewing data.

The audience processing component 352 may build and assign personas using the audience data and a machine-learning algorithm. A persona is an abstraction of a person or groups of people that describes preferences or characteristics about the person or groups of people. The personas may be based on media content the persons have viewed or listened to, as well as other personal information stored in a user profile on the entertainment device (e.g., game console) and associated with the person. For example, the persona could define a person as a female between the ages of 20 and 35 having an interest in science fiction, movies, and sports. Similarly, a person that always has a positive emotional response to car commercials may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The audience distribution component 354 may distribute audience data to content providers, advertisers, or other interested parties. For example, the audience distribution component 354 could provide information indicating that 300,000 discrete individuals viewed a television show in a geographic region. The audience data could be derived from image data received at each entertainment device. In addition to the number of people that viewed the media content, more granular information could be provided. For example, the total persons giving full attention to the content could be provided. In addition, response data for people could be provided. To protect the identity of individual persons, only a persona assigned to a person may be exposed and distributed to advertisers. A value may be placed on the distribution, as a condition on its delivery, as described above. The value may also be based on the amount, type, and dearth of viewing data delivered to an advertiser or content publisher.

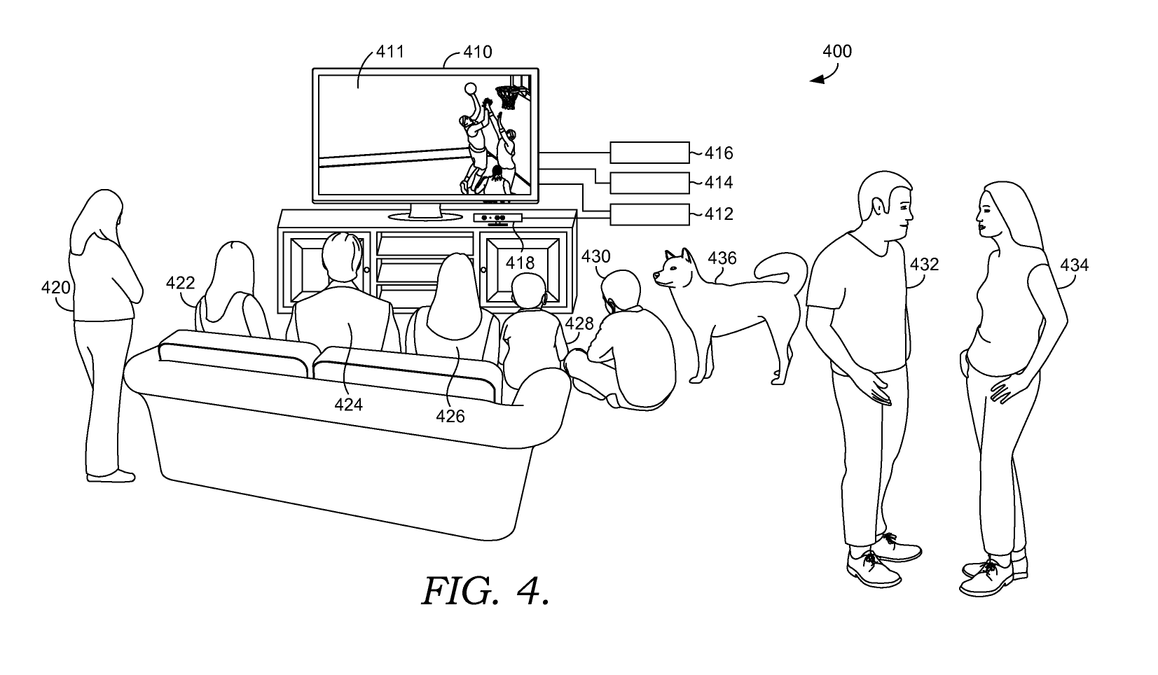

Turning now to FIG. 4, an audience area 400 that includes a group of people is shown, in accordance with an embodiment of the present invention. The audience area is the area in front of the display device 410. In one embodiment, the audience area 400 comprises the area from which a person can see the content. In another embodiment, the audience area 400 comprises the area within a viewing range of the imaging device 418. In most embodiments, however, the viewing range of the imaging device 418 overlaps with the area from which a person can see content on the display device 410. If the content is only audio content, then the audience area is the area where the person may hear the content.

Content is provided to the audience area by an entertainment system that comprises a display device 410, a game console 412, a cable box 414, a DVD player 416, and an imaging device 418. The game console 412 may be similar to game console 210 of FIG. 2 described previously. The cable box 414 and the DVD player 416 may stream content from an entertainment service, such as entertainment service 330 of FIG. 3, to the display device 410 (e.g., television). The game console 412, cable box 414, and the DVD player 416 are all coupled to the display device 410. These devices may communicate content to the display device 410 via a wired or wireless connection, and the display device 410 may display the content. In some embodiments, the content shown on the display device 410 may be selected by one or more persons within the audience. For example, a person in the audience may select content by inserting a DVD into the DVD player 416 or select content by clicking, tapping, gesturing, or pushing a button on a companion device (e.g., a tablet) or a remote in communication with the display device 410. Content selected for viewing may be tracked and stored on the game console 412.

The imaging device 418 is connected to the game console 412. The imaging device 418 may be similar to imaging device 213 of FIG. 2 described previously. The imaging device 418 captures image data of the audience area 400. Other devices that include imaging technology, such as the tablet 212 of FIG. 2, may also capture image data and communicate the image data to the game console 412 via a wireless or wired connection. In FIGS. 4-6, the game console analyzes image data to generate audience data. However, embodiments are not limited to performance by a game console. Other entertainment devices could process imaging data to generate audience data. For example, a television, cable box, stereo receiver, or other entertainment device could analyze imaging data to generate audience data, viewing records, viewing data and other derivates of the image data describing the audience.

In one embodiment, audience data may be gathered through image processing. Audience data may include a detected number of persons within the audience area 400. Persons may be detected based on their form, appendages, height, facial features, movement, speed of movement, associations with other persons, biometric indicators, and the like. Once detected, the persons may be counted and tracked so as to prevent double counting. The number of persons within the audience area 400 also may be automatically updated as people leave and enter the audience area 400.

Audience data may similarly include a direction each audience member is facing. Determining the direction persons are facing may, in some embodiments, be based on whether certain facial or body features are moving or detectable. For example, when certain features, such as a person's cheeks, chin, mouth and hairline are detected, they may indicate that a person is facing the display device 410. Audience data may include a number of persons that are looking toward the display device 410, periodically glancing at the display device 410, or not looking at all toward the display device 410. In some embodiments, a period of time each person views specific media presentations may also comprise audience data.

As an example, audience data may indicate that an individual 420 is standing in the background of the audience area 400 while looking at the display device 410. Individuals 422, 424, 426, and child 428 and child 430 may also be detected and determined to be all facing the display device 410. A man 432 and a woman 434 may be detected and determined to be looking away from the television. The dog 436 may also be detected, but characteristics (e.g., short stature, four legs, and long snout) about the dog 436 may not be stored as audience data because they indicate that the dog 436 is not a person.

Additionally, audience data may include an identity of each person within the audience area 400. Facial recognition technologies may be utilized to identify a person within the audience area 400 or to create and store a new identity for a person. Additional characteristics of the person (e.g., form, height, weight) may similarly be analyzed to identify a person. In one embodiment, the person's determined characteristics may be compared to characteristics of a person stored on the display device 410 in a user profile. If the determined characteristics match those in a stored user profile, the person may be identified as a person associated with the user profile.

Audience data may include personal information associated with each person in the audience area. Exemplary personal characteristics include an estimated age, a race, a nationality, a gender, a height, a weight, a disability, a medical condition, a likely activity level of (e.g., active or relatively inactive), a role within a family (e.g., father or daughter), and the like. For example, based on the image data, an image processor may determine that audience member 420 is a woman of average weight. Similarly, analyzing the width, height, bone structure, and size of individual 432 may lead to a determination that the individual 432 is a male. Personal information may also be derived from stored user profile information. Such personal information may include an address, a name, an age, a birth date, an income, one or more viewing preferences (e.g., movies, games, and reality television shows) of or login credentials for each person. In this way, audience data may be generated based on both processed image data and stored personal profile data. For example, if individual 434 is identified and associated with a personal profile of a 13-year-old, processed image data that classifies individual 434 as an adult (i.e., over 18 years old) may be disregarded as inaccurate.

The audience data also comprises an identification of the primary content being displayed when image data is captured at the imaging device 418. The primary content may, in one embodiment, be identified because it is fed through the game console 412. In other embodiments, and as described above, audio output associated with the display device 410 may be received at a microphone associated with the game console 412. The audio output is then compared to a library of known content and determined to correspond to a known media title or a known genre of media title (e.g., sports, music, movies, and the like). As well, other cues (e.g., whether the person appears to be listening to as opposed to watching a media presentation) may be analyzed to determine the identity of the media content (e.g., a song as opposed to the soundtrack to a movie). Thus, audience data may indicate that basketball game 411 was being displayed to individuals 420, 422, 424, 426, 428, 430, 432, and 434 when images of the individuals were captured. The audience data may also include a mapping of the image data to the exact segment of the media presentation (e.g., basketball game 411) being displayed when the image data was captured.

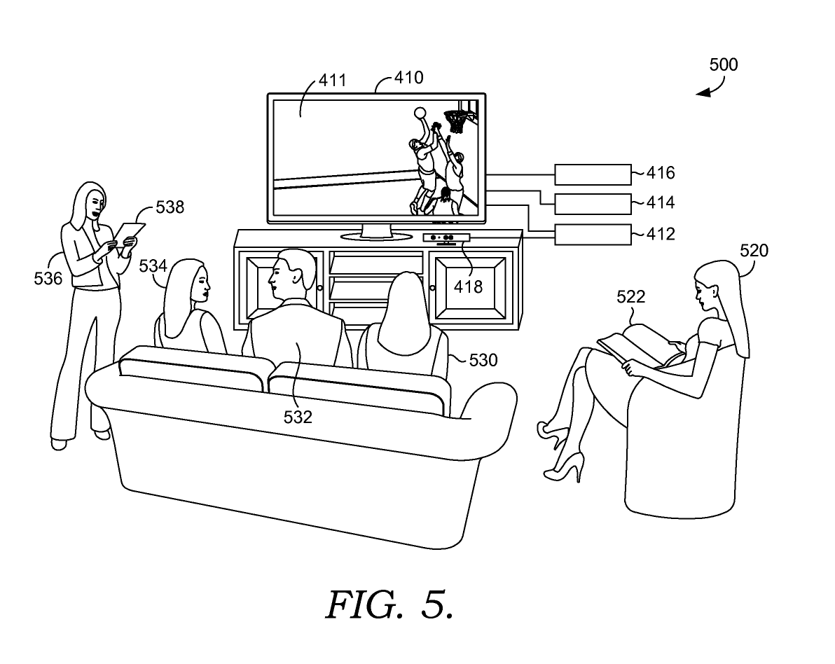

Turning now to FIG. 5, an audience area depicting audience members' levels of engagement is shown, in accordance with an embodiment of the present invention. The entertainment system is identical to that shown in FIG. 4, but the audience members have changed. Image data captured at the imaging device 418 may be processed similarly to how it was processed with reference to FIG. 4. However, in this illustrative embodiment, the image data may be processed to generate audience data that indicates a level of engagement of and/or attention paid by the audience toward the media presentation (e.g., the basketball game 411).

An indication of the level of engagement of a person may be generated based on detected traits of or actions taken by the person, such as facial features, body positioning, and body movement. For example, the movement of a person's eyes, the direction the person's body is facing, the direction the person's face is turned, whether the person is engaged in another task (e.g., talking on the phone), whether the person is talking, the number of additional persons within the audience area 500, and the movement of the person (e.g., pacing, standing still, sitting, or lying down) are traits of and/or actions taken by a person that may be distilled from the image data. The determined traits may then be mapped to predetermined categories or levels of engagement (e.g., a high level of engagement or a low level of engagement). Any number of categories or levels of engagement may be created, and the examples provided herein are merely exemplary.

In another embodiment, a level of engagement may additionally be associated with one or more predetermined categories of distractions. In this way, traits of or actions taken by a person may be mapped to both a level of engagement and a type of distraction. Exemplary actions that indicate a distraction include engaging in conversation, using more than one display device (e.g., the display device 510 and a companion device), reading a book, playing a board game, falling asleep, getting a snack, leaving the audience area 500, walking around, and the like. Exemplary distraction categories may include “interacted with other persons,” “interacted with an animal,” “interacted with other display devices,” “took a brief break,” and the like.

Other input that may be used to determine a person's level of engagement is audio data. Microphones associated with the game console 412 may pick up conversations or sounds from the audience. The audio data may be interpreted and determined to be responsive to (i.e., related to or directed at) the media presentation or nonresponsive to the media presentation. The audio data may be associated with a specific person (e.g., a person's voice). As well, signal data from companion devices may be collected to generate audience data. The signal data may indicate, in greater detail than the image data, a type or identity of a distraction, as described below.

Thus, the image data gathered through imaging device 418 may be analyzed to determine that individual 520 is reading a paper 522 and is therefore distracted from the content shown on display device 510. Individual 536 is viewing tablet 538 while the content is being displayed through display device 510. In addition to observing the person holding the tablet, signal data may be analyzed to understand what the person is doing on the tablet. For example, the person could be surfing the Web, checking e-mail, checking a social network site, or performing some other task. However, the individual 536 could also be viewing secondary content that is related to the primary content 411 shown on display device 510. What the person doing on tablet 538 may cause a different level of engagement to be associated with the person. For example, if the activity is totally unrelated (i.e., the activity is not secondary content), then the level of engagement mapped to the person's action (i.e., looking at the tablet) and associated with the person may be determined to be quite low. On the other hand, if the person is viewing secondary content that compliments the primary content 411, then the individual 536's action of looking at the tablet may be mapped to a somewhat higher level of engagement.

Individuals 532 and 534 are carrying on a conversation with each other but are not otherwise distracted because they are seated in front of the display device 510. If, however, audio input from individuals 532 and 534 indicate that they are speaking with each other while seated in front of the display device 510, their actions may be mapped to an intermediate level of engagement. Only individual 530 is viewing the primary content 411 and not otherwise distracted. Accordingly, a high level of engagement may be associated with individual 530 and/or the media content being displayed.

Determined distractions and levels of engagement of a person may additionally be associated with particular portions of image data, and thus, corresponding portions of media content. As mentioned elsewhere, such audience data may be stored locally on the game console 412 or communicated to a server for remote storage and distribution. The audience data may be stored as a viewing record for the media content. As well, the audience data may be stored in a user profile associated with the person for whom a level of engagement or distractions was determined.

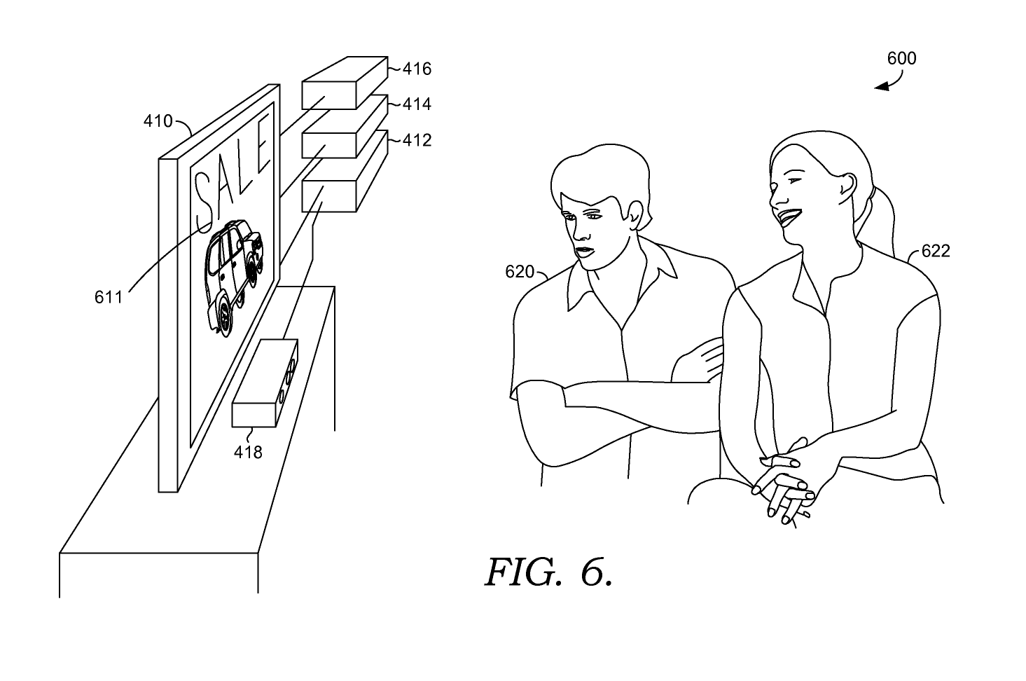

Turning now to FIG. 6, a person's reaction to media content is classified and stored in association with the viewing data. The entertainment setup shown in FIG. 6 is the same as that shown in FIG. 4. However, the primary content 611 is different. In this case, the primary content is a car commercial indicating a sale. In addition to detecting that individuals 620 and 622 are viewing the content and are paying full attention to the content, the persons' responses to the car commercial may be measured through one or more methods and stored as audience data.

In one embodiment, a person's response may be gleaned from the images and/or audio originating from the person (e.g., the person's voice). Exemplary responses include smiling, frowning, wide eyes, glaring, yelling, speaking softly, laughing, crying, and the like. Other responses may include a change to a biometric reading, such as an increased or a decreased heart rate, facial flushing, or pupil dilation. Still other responses may include movement, or a lack thereof, for example, pacing, tapping, standing, sitting, darting one's eyes, fixing one's eyes, and the like. Each response may be mapped to one or more predetermined emotions, such as happiness, sadness, excitement, boredom, depression, calmness, fear, anger, confusion, disgust, and the like. For example, when a person frowns, her frown may be mapped to an emotion of dissatisfaction or displeasure. In embodiments, mapping a person's response to an emotion may additionally be based on the length of time the person held the response or the pronouncement of the person's response. As well, a person's response may be mapped to more than one emotion. For example, a person's response (e.g., smiling and jumping up and down) may indicate that the person is both happy and excited. Additionally, the predetermined categories of emotions may include tiers or spectrums of emotions. Baseline emotions of a person may also be taken into account when mapping a person's response to an emotion. For example, if the person rarely shows detectable emotions, a detected “happy” emotion for the person may be elevated to a higher “tier” of happiness, such as “elation.” As well, the baseline may serve to inform determinations about the attentiveness of the person toward a particular media title.

In some embodiments, only responses and determined emotions that are responsive to the media content being displayed to the person are associated with the media content. Responsiveness may be related to a determined level of engagement of a person, as described above. Thus, responsiveness may be determined based on the direction the person is looking when a title is being displayed. For example, a person that is turned away from the display device is unlikely to be reacting to content being displayed on the display device. Responsiveness may similarly be determined based on the number and type of distractions located within the viewing area of the display device. Similarly, responsiveness may be based on an extent to which a person is interacting with or responding to distractions. For example, a person who is talking on the phone, even though facing and looking at a display screen of the display device, may be experiencing an emotion unrelated to the media content being displayed on the screen. As well, responsiveness may be determined based on whether a person is actively or has recently changed a media title that is being displayed (i.e., a person is more likely to be viewing content he or she just selected to view). It will be understood that responsiveness can be determined in any number of ways by utilizing machine-learning algorithms, and the examples provided herein are meant only to be illustrative.

Thus, returning to FIG. 6, the image data may be utilized to determine responses of individual 622 and individual 620 to the primary content 611. Individual 622 may be determined to have multiple responses to the car commercial, each of which may be mapped to the same or multiple emotions. For example, the individual 622 may be determined to be smiling, laughing, blinking normally, sitting, and the like. All of these reactions, alone and/or in combination, may lead to a determination that the individual 622 is pleased and happy. This is assumed to be a reaction to the primary content 611 and recorded in association with the display event. By contrast, individual 620 is not smiling, has lowered eyebrows, and is crossing his arms, indicating that the individual 620 may be angry or not pleased with the car commercial.

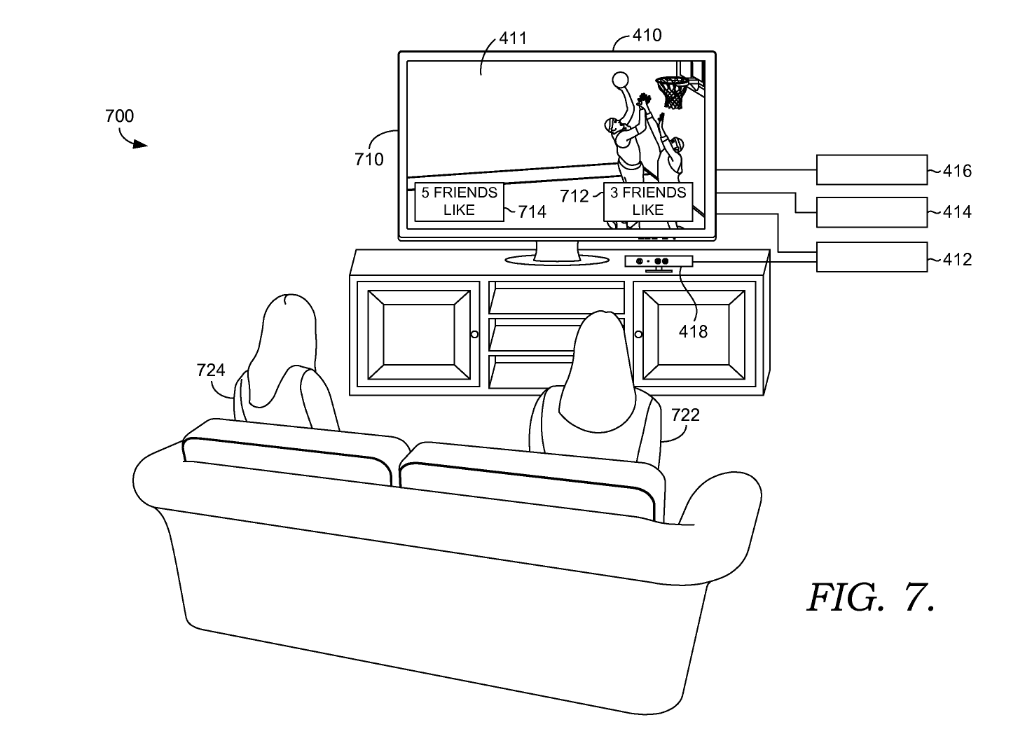

Turning now to FIG. 7, a social overlay is illustrated, in accordance with an embodiment of the present invention. The social overlay interacts with a person's social network. The social overlay may update as new information is received within the person's social network and the person may interact with the overlay to update the social network. In one embodiment, the overlay is a social network search feature that allows the person to search for comments or posts related to a media content shown with the overlay. The social overlay may be updated automatically based on the media content to include a query about a character or actor playing the character within a show. For example, the social query could say, “find out what your friends are saying about Jack Bauer.” Upon giving a selection instruction via voice, gesture, or some other mechanism, the query will be run and results returned. In one embodiment, the results are returned to a secondary companion device associated with the person.

In FIG. 7, a basketball game is shown on television 710. In addition to the basketball game, a social overlay 712 is shown on the right side of the screen and social overlay 714 is shown on the left side of the screen. The social overlay 712 is generated based on individual 722's social network. Overlay 714 is associated with individual 724's network. Social overlay 712 indicates that three friends like the media presentation. Social overlay 714 indicates that five friends like this media presentation. In one embodiment, if the people change places, the social overlays will change places. The social overlays may change their screen location in response to user movements in the room.

As mentioned, the social overlay could relate to an overall media presentation, a subset of the presentation, characters within the presentation, athletes or other performers, or others related to the presentation.

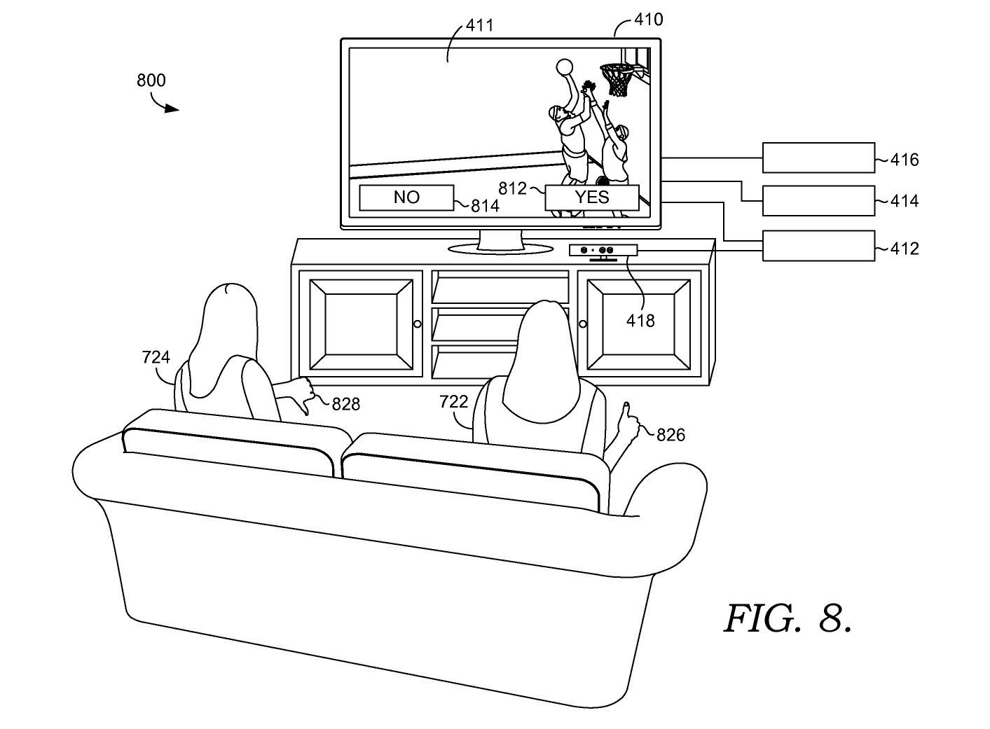

Turning now to FIG. 8, a interactive social overlay is shown, in accordance with an embodiment of the present invention. The interactive social overlay responds to gestures; in this case, interactive overlay 812 shows how many people have responded to a query affirmatively. Interactive overlay 814 indicates how many persons have responded to a query negatively. In this case, the respondents may be within a person's social network or they may not. For example, all people connected to the service could be queried and their results aggregated.

A person may respond to a query, such as “did you agree with that call,” by giving a thumbs up 826 or a thumbs down 828. The imaging data would recognize the gesture and submit a vote. Each person in the room could vote in some embodiments. As the votes are recorded, the vote total is updated in real time and displayed on the screen. The query in question may correspond with the media content. The query could be generated by a person's social network; for example, a friend could ask a question of all of their friends and associate it with the media content. In another embodiment, media providers could generate questions to create interactive shows that are updated in real time.

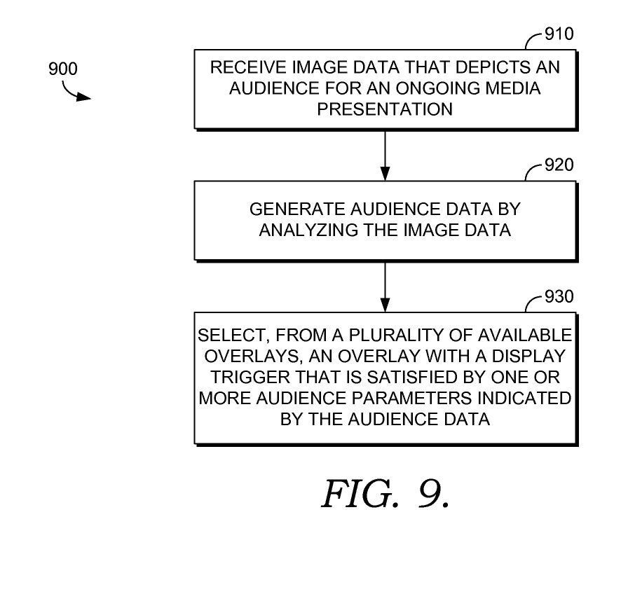

Turning now to FIG. 9, a method 900 of selecting an overlay for display with an ongoing media presentation using audience data is shown, in accordance with an embodiment of the present invention. Examples of overlays have been provided previously. An overlay is visible content displayed over, or on top of, a primary content shown on a display. The overlay may be shown along the bottom of a primary content or along the side. In one embodiment, the overlay temporarily obscures much of the primary content. The overlay may show content that is related or unrelated to the primary content. In one embodiment, the overlay is an advertising overlay.

The overlay may be interactive. An interactive overlay is capable of receiving input from an audience member and acting in response to the input. The audience input could be in the form of a gesture detected through an imaging device, a voice control interface, or through a keyboard or touch screen associated with a secondary device.

At Step 910, image data that depicts an audience for an ongoing media presentation is received. The image data may be in the form of a depth cloud generated by a depth camera, a video stream, still images, skeletal tracking information or other information derived from the image data. The ongoing media presentation may be a movie, game, television show, an advertisement, or the like. Ads shown during breaks in a television show may be considered part of the ongoing media presentation.

The audience may include one or more individuals within an audience area. The audience area includes the extents from which the ongoing media presentation may be viewed from the display device. The individuals within the audience area may be described as audience members herein.

At Step 920, audience data is generated by analyzing the image data. Exemplary audience data has been described previously. The audience data may include a number of people that are present within the audience. For example, the audience data could indicate that five people are present within the audience area. The audience data may also associate audience members with demographic characteristics.

The audience data may also indicate an audience member's level of attentiveness to the ongoing media presentation. Different audience members may be associated with a different level of attentiveness. In one embodiment, the attentiveness is measured using distractions detected within the image data. In other words, a member's interactions with objects other than the display may be interpreted as the member paying less than full attention to the ongoing media presentation. For example, if the audience member is interacting with a different media presentation (e.g., reading a book, playing a game) then less than full attentiveness is paid to the ongoing media presentation. Interactions with other audience members may indicate a low level of attentiveness. Two audience members having a conversation may be assigned less than a full attentiveness level. Similarly, an individual speaking on a phone may be assigned less than full attention.

In addition to measuring distractions, an individual's actions in relation to the ongoing media presentation may be analyzed to determine a level of attentiveness. For example, the user's gaze may be analyzed to determine whether the audience member is looking at the display. When multiple content items are shown within the ongoing media presentation, such as an overlay over a primary content, gaze detection may be used to determine whether the user is ignoring the overlay and looking at the ongoing media presentation or is focused on the overlay, or even noticed the overlay for a short period. Thus, attentiveness information could be assigned to different content shown on a single display.

The audience data may also measure a user's reaction or response to the ongoing media presentation. As mentioned previously with reference to FIG. 6, a user's response or reaction may be measured based on biometric data and facial expressions.

The audience data may be supplemented with past viewing history of one or more audience members. Audience member's previous interactions with overlays may also be described by the audience data. For example, the audience data may indicate that an audience member has twice ignored a previously displayed overlay. Other data sources and/or services such as the users' social network, purchase history, or recent viewing history may be used to generate data used in combination with audience data to select an overaly.

At Step 930, an overlay that has a display trigger satisfied by one or more audience parameters indicated by the audience data is selected from a plurality of available overlays. The selected overlay may be displayed to the user concurrently with the ongoing media presentation.

The display triggers correlate with parameters of the audience data described previously. For example, a display trigger may require that at least one person is present in the audience. In other words, a trigger may prevent an overlay from being displayed when nobody is watching an ongoing media presentation. The characteristics of one or more audience members may also be used as a display trigger. Some overlays may be optimized for display to audience members having different demographic profiles. For example, a first advertising overlay may be optimized for display to men while a second advertising overlay is optimized for display to women. As mentioned, the demographic data could also include a user's interests as derived from a viewing history, measured reactions to content, and the like. Thus, a display trigger could be an audience member known to be interested in exercise, be a car enthusiast, or have any other interests that could be correlated with an overlay.

The display trigger could be a level of attentiveness. In one embodiment, the display trigger requires that at least one audience member is categorized as presently, in real time, paying full attention to the ongoing media presentation. Similarly, the display trigger could be an audience member positively responding to a category of content. The response could be measured explicitly or implicitly. For example, users may be invited to make a gesture to indicate they like a content, such as a product placement within a media presentation. In another embodiment, the response is measured implicitly through biometric and other imaging data that is assumed to reflect a response to the media presentation at the time the biometric data was observed. For example, a user demonstrating a positive response to a car commercial earlier in an ongoing media presentation may be shown an overlay inviting the user to request more information about the car in the commercial.

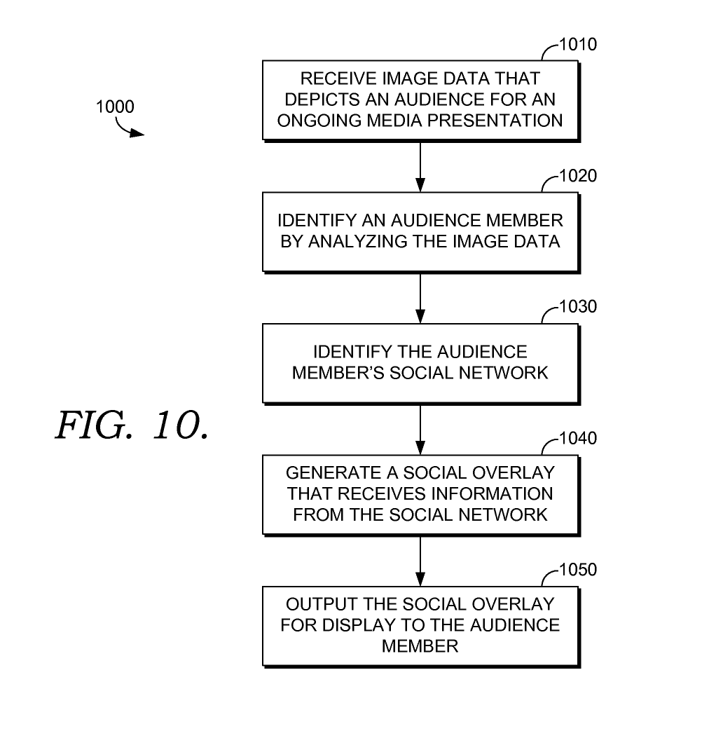

Turning now to FIG. 10, a method 1000 of generating a social overlay is shown, in accordance with an embodiment of the present invention. Social overlays have been described previously with reference to FIGS. 7 and 8. A social overlay is capable of interacting with an audience member's social network. The interaction may include retrieving information from an audience member's social network and posting information to the audience member's social network. An audience member's social network may comprise multiple networks to which the member belongs. For example, a user's social network could include friends within Facebook, followers within Twitter, and connections within any other social networks to which the member belongs.

At Step 1010, image data that depicts an audience for an ongoing media presentation is received. At Step 1020, an audience member is identified by analyzing the image data. In one embodiment, the audience member is identified through facial recognition. For example, the audience member may be associated with a user account that provides facial recognition authentication or login. The audience member's account may then be associated with one or more social networks. In one embodiment, social networks are associated with a facial recognition login feature that allows the audience member to be associated with a social network.

The audience member may be given an opportunity to explicitly associate his account with one or more social networks. The audience member may be a member of more social networks than are actually associated with the account. But embodiments of the present invention may work with whatever social networks the audience member has provided access to. Upon determining that the audience member is associated with a social network, the audience member may be asked to provide authentication information or permission to access the social network. This information may be requested through a setup overlay or screen. The setup may occur at a point separate from when the media presentation is ongoing, for example, when an entertainment device is set up.

At Step 1030, the audience member's social network is identified. As mentioned, the audience member's social network may comprise multiple social networks. And the social network of step 1030 could include less than all of the social networks to which the audience member belongs. In one embodiment, an audience member's name is used to retrieve presumptive social network accounts. The audience member may be asked to verify whether the social network account belongs to the audience member and further asked to provide authentication information.

At Step 1040, a social overlay that receives information from the social network is generated. The information received from the social network may comprise commentary about the ongoing media presentation. For example, commentary about the ongoing media presentation may be extracted from posts created by members of the audience members' social network. The content posted within the social overlay could be a snippet derived from the commentary. In one embodiment, the social overlay aggregates information from multiple members of the audience member's social network. For example, the social overlay could indicate that five of the audience member's social contacts like the ongoing media presentation.

The social overlay may also facilitate the creation of a social post on behalf of the audience member. For example, the audience member could make a gesture to indicate he likes or dislikes the ongoing media presentation and that could become part of a social post. In one embodiment, the social post is automatically associated with the ongoing media presentation without input from the audience member. For example, a hash tag describing the ongoing media presentation may be added to a social post. In another embodiment, a link to the ongoing media presentation is automatically generated and included within the social overlay. In yet another embodiment, a description, such as the media presentation's title, is automatically included within the social post or metadata associated with the post.

At Step 1040, the social overlay is output for display to the audience member. In one embodiment, the social overlay is an advertising overlay that includes sponsorship information. The social overlay may be generated using a template that includes space for an advertising sponsor. The advertising sponsor may be selected by analyzing audience data that is generated through the image data. The advertising sponsor may be associated with different display triggers, as described previously.

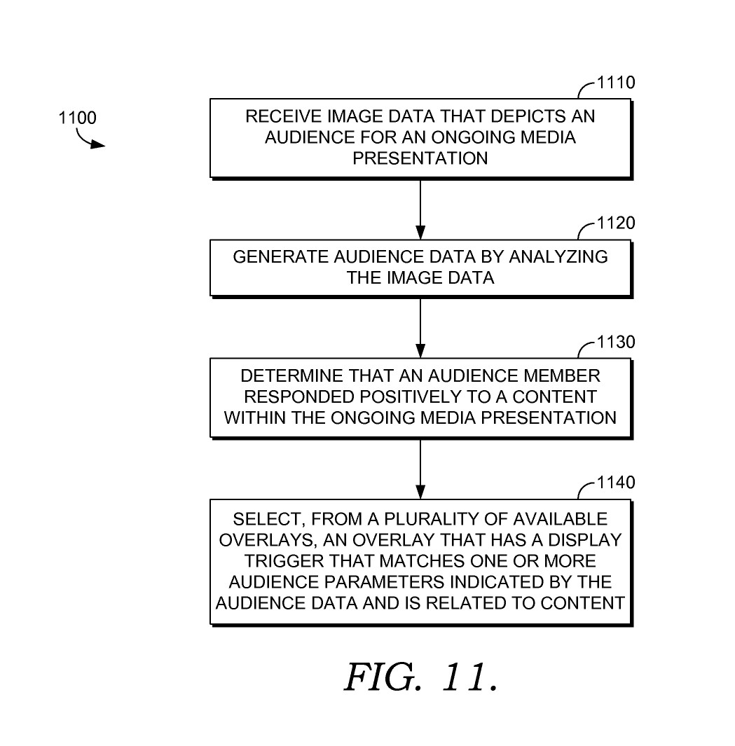

Turning now to FIG. 11, a method 1100 of managing an overlay display is shown, in accordance with an embodiment of the present invention. At Step 1110, image data that depicts an audience for an ongoing media presentation is received. At Step 1120, audience data is generated by analyzing the image data. As mentioned, the audience data could include the number of people within the audience area, characteristics of those people, attentiveness paid to the ongoing media presentation by those people and a reaction or response to the media content.

At Step 1130, an audience member is determined to have responded positively to a content within the ongoing media presentation. The content may be determined using metadata associated with different points in the ongoing media presentation. For example, metadata indicating a product placement could be included and a response measured contemporaneously with the product placement appearing within the ongoing media presentation. Metadata could also describe characters or individuals appearing within the ongoing media presentation.

In one embodiment, the audience member is determined to have responded positively by making an explicit gesture. For example, the member may make a thumbs up gesture to indicate she likes an ongoing content. In another embodiment, the member is invited to provide input by making a gesture explained within an overlay shown contemporaneously with the content. In one embodiment, the content is a product placement within a show. The product placement and its point of appearance in a shown may be identified using metadata. In another embodiment, automatic content recognition is used to identify products within a show that are not included via product placement. For example, the overlay may ask the member to make a driving gesture (i.e., move hands as if the member were turning a steering wheel) to indicate she likes the car shown in a car commercial or in response to seeing a car in a show. Other correlations with a product and a gesture could be used to determine that the member likes or responds positively to the content. Thus, the overlay could be a gesture training overlay that provides instructions on how to make a gesture that allows the audience member to express his approval or disapproval of a product or content. A subsequent commercial or overlay could be shown based on the user expressing approval for the product in response to the first overall or first presentation of the product within content.

In one embodiment, speech recognition may be used to determine whether the audience member liked or disliked a content. For example, the member could say, “Tell me more.” Other expressions of approval or requests for additional information, including a channel for receiving that information, may be expressed. For example, the user could request that additional information is communicated via e-mail or shown through a companion application on a companion device, such as a table.

At Step 1140, an overlay that has a display trigger that matches one or more audience parameters indicated by the audience data and that is related to the content is selected from a plurality of available overlays. The overlay may be output for display to the audience member. For one embodiment, the overlay is interactive and allows the member to provide input that is aggregated with input received from other users to provide a group result. The result may be periodically updated. For example, a member may be asked whether he approves or disapproves of an official's call within a sporting event. In this way, a real-time survey could be conducted and the results displayed within one or more overlays shown in conjunction with the ongoing media presentation. The voting displays may be sponsored by one or more advertisers.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of selecting an overlay for an ongoing media presentation using audience data, the method comprising:
receiving image data that depicts an audience for an ongoing media presentation;
generating audience data by analyzing the image data; and
selecting, from a plurality of available overlays, an overlay with a display trigger that is satisfied by one or more audience parameters indicated by the audience data.

2. The media of claim 1, wherein the method further comprises determining an audience member's reaction to the ongoing media presentation by analyzing the image data and including the audience member's reaction as an audience parameter within the audience data.

3. The media of claim 1, wherein the method further comprises determining an audience member's level of attentiveness to the ongoing media presentation by analyzing the image data and including the audience member's level of attentiveness as an audience parameter within the audience data.

4. The media of claim 1, wherein the method further comprises determining demographic information for an audience member by analyzing the image data and including the demographic information as an audience parameter within the audience data.

5. The media of claim 4, wherein the method further comprises associating the audience member with a user account and retrieving the demographic information for the audience member from the user account.

6. The media of claim 1, wherein the display trigger specifies that an audience member is presently associated with a designated level of attentiveness.

7. The media of claim 1, wherein the display trigger specifies that an audience member is associated with a positive reaction to a category of content into which a content in the overlay is classified.

8. The media of claim 1, wherein the display trigger specifies an audience member having a specified demographic profile and the audience members have a specified level of engagement.

9. A method of generating a social overlay, the method comprising:
receiving image data that depicts an audience for an ongoing media presentation;
identifying an audience member by analyzing the image data;
identifying the audience member's social network;
generating a social overlay that receives information from the social network; and
outputting the social overlay for display to the audience member.

10. The method of claim 9, wherein the audience member is identified through facial recognition.

11. The method of claim 9, further comprises:
retrieving commentary about the ongoing media presentation from social posts generated by individuals within the audience member's social network; and
including at least part of the commentary within the social post.

12. The method of claim 9, further comprising:
generating a social post to the audience member's social network in response to input received from the audience member during the ongoing media presentation.

13. The method of claim 12, wherein the social post is automatically identified as related to the ongoing media presentation without additional input from the audience member.

14. The method of claim 9, wherein the social overlay asks for a response from the audience member and the method further comprises:
receiving a response to the social overlay from the audience member; and
aggregating the response with additional responses received from other people viewing the ongoing media presentation to form a response summary; and
updating the social overlay to display the response summary.

15. The method of claim 9, further comprising:
generating audience data by analyzing the image data;
determining that display triggers associated with each of a plurality of advertising sponsors for the social overlay are satisfied by the audience data;
selecting, from the plurality of advertising sponsors, an advertising sponsor with the highest monetary return for display of the advertising overlay; and
including advertising content from the advertising sponsor within the social overlay.

16. One or more computer-storage media having computer-executable instructions embodied thereon that when executed by a computing device perform a method of managing an overlay display, the method comprising:
receiving image data that depicts an audience for an ongoing media presentation;
generating audience data by analyzing the image data;
determining that an audience member responded positively to a content within the ongoing media presentation; and
selecting, from a plurality of available overlays, an overlay that has a display trigger that matches one or more audience parameters indicated by the audience data and that is related to content.

17. The media of claim 16, wherein the audience member responded positively by performing a gesture.

18. The media of claim 17, wherein the gesture is a thumbs up.

19. The media of claim 17, wherein the content is a product placement within ongoing media presentation.

20. The media of claim 16, wherein the method further comprises displaying a feedback overlay that invites the audience member to respond to content within the ongoing media presentation.
